(19) United States
(12) Patent Application Publication
(10) Pub. No.: US 2019/0392352 A1
(43) Pub. Date: Dec. 26, 2019

(54) ADAPTIVE PROGRAMMING OF QUANTUM DOT QUBIT DEVICES

(71) Applicant: Intel Corporation, Santa Clara, CA (US)

(72) Inventors: Lester Lampert, Portland, OR (US); Ravi Pillarisetty, Portland, OR (US); Nicole K. Thomas, Portland, OR (US); Hubert C. George, Portland, OR (US); Jeanette M. Roberts, North Plains, OR (US); David J. Michalak, Portland, OR (US); Roman Caudillo, Portland, OR (US); Zachary R. Yoscovits, Beaverton, OR (US); James S. Clarke, Portland, OR (US)

(73) Assignee: Intel Corporation, Santa Clara, CA (US)

(21) Appl. No.: 16/016,840

(22) Filed: Jun. 25, 2018

(51) Int. Cl. G06N 99/00; G06F 15/18; G06F 17/18; G06F 1/20

(52) U.S. Cl. CPC G06N 99/002; G06F 1/20; G06F 17/18; G06F 15/18

(57) ABSTRACT

Embodiments of the present disclosure provide quantum circuit assemblies that implement adaptive programming of quantum dot qubit devices. An example quantum circuit assembly includes a quantum circuit component including a quantum dot qubit device, and a control logic coupled to the quantum circuit component. The control logic is configured to adaptively program the quantum dot qubit device by iterating a sequence of applying one or more signals to the quantum dot qubit device, determining a state of at least one qubit of the quantum dot qubit device, and using the determined state to modify the signals to be applied to the quantum dot qubit device in the next iteration. In this manner, the signals may be fine-tuned to achieve a higher probability of the qubit(s) in the quantum dot qubit device being set to the desired state.

### TECHNICAL FIELD

This disclosure relates generally to the field of quantum computing.

### BACKGROUND

Quantum computing refers to the field of research related to computation systems that use quantum-mechanical phenomena to manipulate data. These quantum-mechanical phenomena, such as superposition (in which a quantum variable can simultaneously exist in multiple different states) and entanglement (in which multiple quantum variables have related states irrespective of the distance between them in space or time), do not have analogs in the world of classical computing, and thus cannot be implemented with classical computing devices.

Quantum computers use so-called quantum bits, referred to as qubits (both terms “bits” and “qubits” often interchangeably refer to the values that they hold as well as to the actual devices that store the values). Similar to a bit of a classical computer, at any given time, a qubit can be either 0 or 1. However, in contrast to a bit of a classical computer, a qubit can also be 0 and 1 at the same time, which is a result of superposition of quantum states—a uniquely quantum-mechanical phenomenon. Entanglement also contributes to the unique nature of qubits in that input data to a quantum processor can be spread out among entangled qubits, allowing manipulation of that data to be spread out as well: providing input data to one qubit results in that data being shared to other qubits with which the first qubit is entangled.

Designing quantum circuits is a non-trivial task because the unique quantum mechanical phenomena in such circuits lead to unique considerations which never had to be dealt with in classical, non-quantum, circuits, such as e.g. taking precautions in protecting qubits from decoherence so that they can stay in their information-holding states long enough to perform the necessary calculations and read out the results, and ability to operate at cryogenic temperatures. That is why, compared to well-established and thoroughly researched classical computers, quantum computing is still in its infancy, with the highest number of qubits in a solid-state quantum processor currently being below 100. As the applications needing quantum circuits grow, the need for quantum circuit assemblies having improved performance also grows.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIGS. 1-3 are cross-sectional views of an example quantum dot qubit device implementing quantum dot qubits, according to some embodiments of the present disclosure.

FIGS. 4-6 are cross-sectional views of various examples of quantum well stacks that may be used in a quantum dot qubit device, according to some embodiments of the present disclosure.

FIGS. 7-13 illustrate example base/fin arrangements that may be used in a quantum dot qubit device, according to some embodiments of the present disclosure.

FIG. 14 provides a schematic illustration of a quantum circuit assembly configured to implement adaptive programming of quantum dot qubit devices, according to some embodiments of the present disclosure.

FIG. 15 provides a schematic illustration of a data processing system configured to implement at least portions of adaptive programming of a quantum dot qubit device, according to some embodiments of the present disclosure.

FIG. 16 provides a flow charts of an example method of adaptive programming of a quantum dot qubit device, according to some embodiments of the present disclosure.

FIGS. 17A and 17B are top views of a wafer and dies that may include one or more of quantum circuit assemblies configured to implement adaptive programming of quantum dot qubit devices, according to some embodiments of the present disclosure.

FIG. 18 is a cross-sectional side view of a device assembly that may include one or more of quantum circuit assemblies configured to implement adaptive programming of quantum dot qubit devices, according to some embodiments of the present disclosure.

FIG. 19 is a block diagram of an example quantum computing device that may include one or more of quantum circuit assemblies configured to implement adaptive programming of quantum dot qubit devices, according to some embodiments of the present disclosure.

### DETAILED DESCRIPTION

### Overview

As briefly described above, quantum computing, or quantum information processing, refers to the field of research related to computation systems that use quantum-mechanical phenomena to store and manipulate data. One example of quantum-mechanical phenomena is the principle of quantum superposition, which asserts that any two or more quantum states can be added together, i.e. superposed, to produce another valid quantum state, and that any quantum state can be represented as a sum of two or more other distinct states. Quantum entanglement is another example of quantum-mechanical phenomena. Entanglement refers to groups of particles or quantum bits being generated or made to interact in such a way that the state of one particle becomes intertwined with that of the others. Furthermore, the quantum state of each qubit cannot be described independently. Instead, the quantum state is given for the group of entangled particles as a whole. For example, two entangled qubits may be represented by a superposition of 4 quantum states, and N entangled qubits may be represented by a superposition of 2″ quantum states. Yet another example of quantum-mechanical phenomena is sometimes described as a “collapse” because it asserts that when we observe (measure) qubits, we unavoidably change their properties in that, once observed, the qubits cease to be in a state of superposition or entanglement (i.e. by trying to ascertain anything about the particles, we collapse their state) and collapse to one of the 2″ quantum states.

Put simply, superposition postulates that a given qubit can be simultaneously in two states; entanglement postulates that two qubits can be related in that they are able to instantly coordinate their states irrespective of the distance between them in space and time so as to exist in a superposition of 4 states or in the case of N qubits in a superposition of 2″ quantum states; and collapse postulates that when one observes a qubit, one unavoidably changes the state of the qubit and its entanglement with other qubits. These unique phenomena make manipulation of data in quantum computers significantly different from that of classical computers (i.e. computers that use phenomena of classical physics). Therefore, both industry and academia continue to focus on a search for new and improved physical systems whose functionality could approach that expected of theoretically designed qubits. Physical systems for implementing qubits that have been explored until now include e.g. quantum dot qubit devices, superconducting devices, single trapped ion devices, photon polarization devices, etc. To indicate that these devices implement qubits, sometimes these devices are referred to as qubits, e.g. quantum dot qubits, superconducting qubits, etc.

Quantum dot qubit devices are promising candidates for building a quantum computer because they may be manufactured using existing process tools of leading-edge device manufacturers. Operation of quantum dot qubit devices typically begins with initialization of qubits, a process of programming the qubits that includes applying one or more signals to various gates of the quantum dot qubit devices to set different qubits to desired initial quantum states. In context of quantum dot qubit devices, a state of a qubit refers to a spin state, i.e. one of two allowed values of a spin component (i.e. one of two of the allowed spin states, e.g. a spin up state or a spin down state). The spin state of a quantum dot qubit maps well to a logical qubit as the measured outcome of said state collapses to one of two possible values—either spin up or spin down. One challenge with such operation is that, due to the fragile nature of quantum dot qubits, application of signals which are expected to lead to the desired qubit states does not always result in qubits being set to those desired states. This may cause errors and uncertainties further down the line of processes carried out to operate the qubits and may even compromise the entire operation.

Embodiments of the present disclosure provide quantum circuit assemblies that implement adaptive programming of quantum dot qubit devices. An example quantum circuit assembly includes a quantum circuit component including a quantum dot qubit device (a term that may be used interchangeably with a term “quantum dot qubit”), and a control logic coupled to the quantum circuit component. The control logic is configured to adaptively program the quantum dot qubit device by iterating (i.e. performing a plurality of times) a sequence of applying one or more signals to the quantum dot qubit device, determining a state of at least one qubit (or a state of each of one or more qubits of) the quantum dot qubit device, and using the determined state(s) to modify the signals to be applied to the quantum dot qubit device in the next iteration. In this manner, the signals may be fine-tuned to achieve a higher probability of the desired qubit(s) in the quantum dot qubit device being eventually set to the desired state. In some embodiments, the control logic may be configured to implement machine learning and other predictive methodologies to gradually adapt the signals applied to quantum dot qubit devices. Advantages of such an approach to initializing quantum dot qubit devices may include reduced error rates during operation of the qubits, improved tuning, and ability to speed up the initialization process.

In various embodiments, quantum circuit assemblies implementing adaptive programming of quantum dot qubit devices as described herein may be used to implement components associated with a quantum integrated circuit (IC). Such components may include those that are mounted on or embedded in a quantum IC, or those connected to a quantum IC. The quantum IC may be either analog or digital and may be used in a number of applications within or associated with quantum systems, such as e.g. quantum processors, quantum amplifiers, quantum sensors, etc., depending on the components associated with the integrated circuit. The integrated circuit may be employed as part of a chipset for executing one or more related functions in a quantum system.

While the descriptions are provided herein with reference to quantum dot qubits, at least some teachings of the present disclosure may be applicable to implementations of any qubits, e.g. including spin qubits other than quantum dot qubits and/or including qubits other than spin qubits, which may implement adaptive programming as described herein, all of which implementations are within the scope of the present disclosure. In some embodiments, the quantum circuit device assemblies described herein may be used in hybrid semiconducting-superconducting quantum circuits.

In the following detailed description, reference is made to the accompanying drawings that form a part hereof, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense.

In the drawings, some schematic illustrations of example structures of various devices and assemblies described herein may be shown with precise right angles and straight lines, but it is to be understood that such schematic illustrations may not reflect real-life process limitations which may cause the features to not look so “ideal” when any of the structures described herein are examined using e.g. scanning electron microscopy (SEM) images or transmission electron microscope (TEM) images. In such images of real structures, possible processing defects could also be visible, such as e.g. tapered vias or other openings, inadvertent rounding of corners or variations in thicknesses of different material layers, occasional screw, edge, or combination dislocations within the crystalline region, and/or occasional dislocation defects of single atoms or clusters of atoms.

Various operations may be described as multiple discrete actions or operations in turn in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges. As used herein, the notation “A/B/C” means (A), (B), and/or (C).

The description uses the phrases “in an embodiment” or “in embodiments,” which may each refer to one or more of the same or different embodiments. Furthermore, the terms “comprising,” “including,” “having,” and the like, as used with respect to embodiments of the present disclosure, are synonymous. The disclosure may use perspective-based descriptions such as “above,” “below,” “top,” “bottom,” and “side”; such descriptions are used to facilitate the discussion and are not intended to restrict the application of disclosed embodiments. The accompanying drawings are not necessarily drawn to scale. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

The terms “over,” “under,” “between,” and “on” as used herein refer to a relative position of one material layer or component with respect to other layers or components. For example, one layer disposed over or under another layer may be directly in contact with the other layer or may have one or more intervening layers. Moreover, one layer disposed between two layers may be directly in contact with the two layers or may have one or more intervening layers. In contrast, a first layer “on” a second layer is in direct contact with that second layer. Similarly, unless explicitly stated otherwise, one feature disposed between two features may be in direct contact with the adjacent features or may have one or more intervening layers.

In the following detailed description, various aspects of the illustrative implementations will be described using terms commonly employed by those skilled in the art to convey the substance of their work to others skilled in the art. For example, the terms “oxide,” “carbide,” “nitride,” etc. refer to compounds containing, respectively, oxygen, carbon, nitrogen, etc. The terms “substantially,” “close,” “approximately,” “near,” and “about,” generally refer to being within +/−20% of a target value based on the context of a particular value as described herein or as known in the art. Similarly, terms indicating orientation of various elements, such as e.g. “perpendicular,” “parallel,” or any other angle between the elements, generally refer to being within +/−5-10% of a target value based on the context of a particular value as described herein or as known in the art.

Still further, while the present disclosure may include references to microwave signals, this is done only because current qubits are designed to work with such signals because the energy in the microwave range is higher than thermal excitations at the temperature that qubits are typically operated at. In addition, techniques for the control and measurement of microwaves are well known. For these reasons, typical frequencies of qubits are in 1-10 GHz, e.g. in 4-10 GHz, range, in order to be higher than thermal excitations, but low enough for ease of microwave engineering. However, advantageously, because excitation energy of qubits is controlled by the circuit elements, qubits can be designed to have any frequency. Therefore, in general, qubits could be designed to operate with signals in other ranges of electromagnetic spectrum and embodiments of the present disclosure could be modified accordingly. All of these alternative implementations are within the scope of the present disclosure.

Example Quantum Circuit Components with Quantum Dot Qubits

Quantum dot qubit devices may enable the formation of quantum dots to serve as quantum bits (i.e. as “quantum dot qubits” or simply “qubits”) in a quantum computing device. One type of quantum dot qubit devices includes devices having a base, a fin extending away from the base, where the fin includes a quantum well layer, and one or more gates disposed on the fin. A quantum dot formed in such a device may be constrained in the x-direction by the one or more gates, in the y-direction by the fin, and in the z-direction by the quantum well layer, as discussed in detail herein. Unlike previous approaches to quantum dot formation and manipulation, quantum dot qubit devices with fins provide strong spatial localization of the quantum dots (and therefore good control over quantum dot interactions and manipulation), good scalability in the number of quantum dots included in the device, and/or design flexibility in making electrical connections to the quantum dot qubit devices to integrate the quantum dot qubit devices in larger computing devices. Therefore, this is the type of quantum dot qubit device that is described herein as an example of a device that may be included in a quantum circuit component that may be implemented with adaptive programming techniques according to various embodiments of the present disclosure.

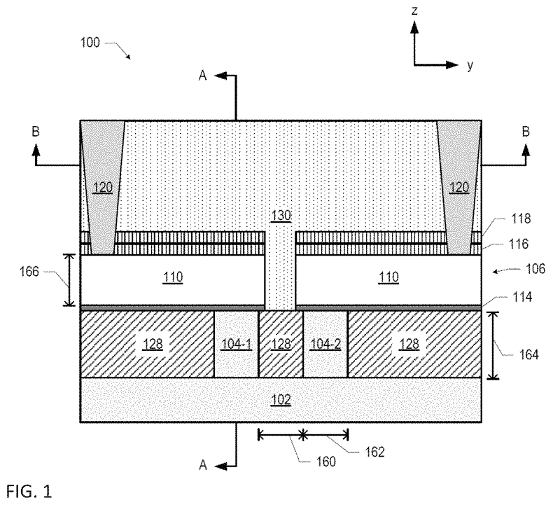

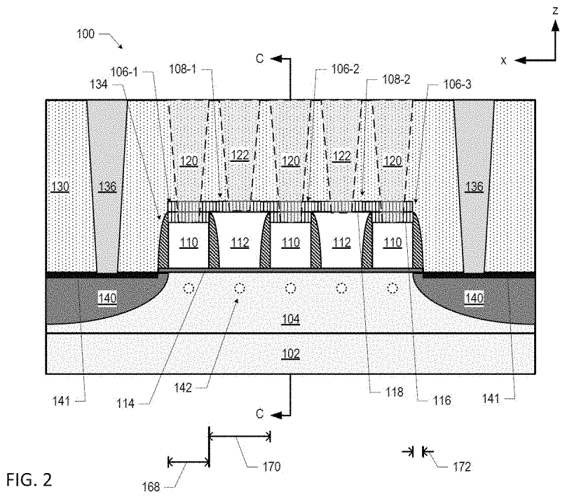

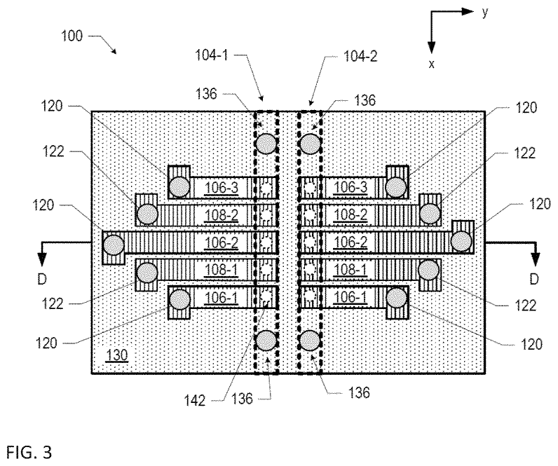

FIGS. 1-3 are cross-sectional views of an example quantum dot qubit device 100 implementing quantum dot qubits, in accordance with various embodiments. In particular, FIG. 2 illustrates the quantum dot qubit device 100 taken along the section A-A of FIG. 1 (while FIG. 1 illustrates the quantum dot qubit device 100 taken along the section C-C of FIG. 2), and FIG. 3 illustrates the quantum dot qubit device 100 taken along the section B-B of FIG. 1 (while FIG. 1 illustrates a quantum dot qubit device 100 taken along the section D-D of FIG. 3). Although FIG. 1 indicates that the cross-section illustrated in FIG. 2 is taken through the fin 104-1, an analogous cross section taken through the fin 104-2 may be identical, and thus the discussion of FIGS. 1-3 refers generally to the “fin 104.”

A quantum circuit component of a quantum circuit assembly implementing adaptive programming of quantum dot qubit devices as described herein may include one or more of the quantum dot qubit devices 100.

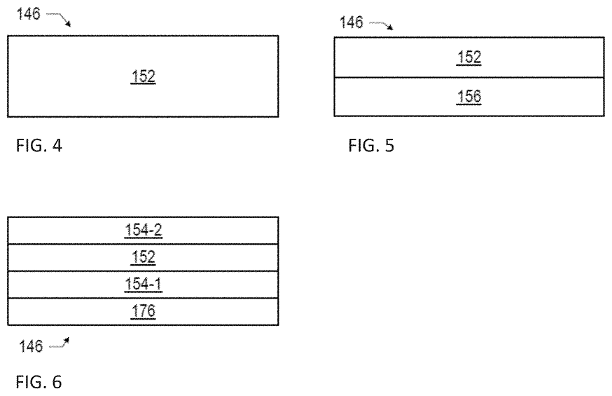

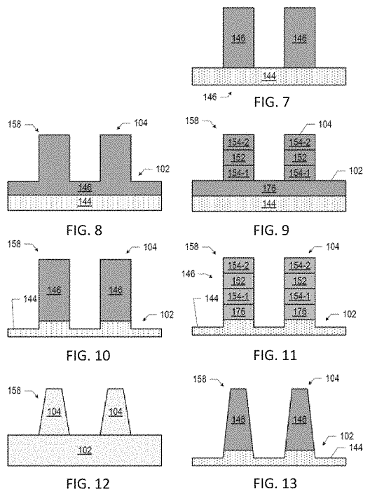

As shown in FIGS. 1-3, the quantum dot qubit device 100 may include a base 102 and multiple fins 104 extending away from the base 102. The base 102 and the fins 104 may include a semiconductor substrate and a quantum well stack (not shown in FIGS. 1-3, but discussed below with reference to the semiconductor substrate 144 and the quantum well stack 146), distributed in any of a number of ways between the base 102 and the fins 104. The base 102 may include at least some of the semiconductor substrate, and the fins 104 may each include a quantum well layer of the quantum well stack (discussed below with reference to the quantum well layer 152 of FIGS. 4-6). Examples of base/fin arrangements are discussed below with reference to the base fin arrangements 158 of FIGS. 7-13.

Although only two fins, 104-1 and 104-2, are shown in FIGS. 1-3, this is simply for ease of illustration, and more than two fins 104 may be included in the quantum dot qubit device 100. In some embodiments, the total number of fins 104 included in the quantum dot qubit device 100 is an even number, with the fins 104 organized into pairs including one active fin 104 and one read fin 104, as discussed in detail below. When the quantum dot qubit device 100 includes more than two fins 104, the fins 104 may be arranged in pairs in a line (e.g., 2N fins total may be arranged in a 1×2N line, or a 2×N line) or in pairs in a larger array (e.g., 2N fins total may be arranged as a 4×N/2 array, a 6×N/3 array, etc.). The discussion herein will largely focus on a single pair of fins 104 for ease of illustration, but all the teachings of the present disclosure apply to quantum dot qubit devices 100 with more fins 104.

As noted above, each of the fins 104 may include a quantum well layer (not shown in FIGS. 1-3, but discussed below with reference to the quantum well layer 152). The quantum well layer included in the fins 104 may be arranged normal to the z-direction, and may provide a layer in which a two-dimensional electron gas (2DEG) may form to enable the generation of a quantum dot during operation of the quantum dot qubit device 100, as discussed in further detail below. The quantum well layer itself may provide a geometric constraint on the z-location of quantum dots in the fins 104, and the limited extent of the fins 104 (and therefore the quantum well layer) in the y-direction may provide a geometric constraint on the y-location of quantum dots in the fins 104. To control the x-location of quantum dots in the fins 104, voltages may be applied to gates disposed on the fins 104 to adjust the energy profile along the fins 104 in the x-direction and thereby constrain the x-location of quantum dots within quantum wells (discussed in detail below with reference to the gates 106/108). The dimensions of the fins 104 may take any suitable values. For example, in some embodiments, the fins 104 may each have a width 162 between 10 and 30 nanometers. In some embodiments, the fins 104 may each have a height 164 between 200 and 400 nanometers (e.g., between 250 and 350 nanometers, or equal to 300 nanometers).

The fins 104 may be arranged in parallel, as illustrated in FIGS. 1 and 3, and may be spaced apart by an insulating material 128, which may be disposed on opposite faces of the fins 104. The insulating material 128 may be a dielectric material, such as silicon oxide. For example, in some embodiments, the fins 104 may be spaced apart by a distance 160 between 100 and 250 microns.

Multiple gates may be disposed on each of the fins 104. In the embodiment illustrated in FIG. 2, three gates 106 and two gates 108 are shown as distributed on the top of the fin 104. This particular number of gates is simply illustrative, and any suitable number of gates may be used. Additionally, multiple groups of gates like the gates illustrated in FIG. 2 may be disposed on the fin 104.

As shown in FIG. 2, the gate 108-1 may be disposed between the gates 106-1 and 106-2, and the gate 108-2 may be disposed between the gates 106-2 and 106-3. Each of the gates 106/108 may include a gate dielectric 114. In the embodiment illustrated in FIG. 2, the gate dielectric 114 for all of the gates 106/108 is provided by a common layer of gate dielectric material. In other embodiments, the gate dielectric 114 for each of the gates 106/108 may be provided by separate portions of gate dielectric 114. In some embodiments, the gate dielectric 114 may be a multilayer gate dielectric (e.g., with multiple materials used to improve the interface between the fin 104 and the corresponding gate metal). The gate dielectric 114 may be, for example, silicon oxide, aluminum oxide, or a high-k dielectric, such as hafnium oxide. More generally, the gate dielectric 114 may include elements such as hafnium, silicon, oxygen, titanium, tantalum, lanthanum, aluminum, zirconium, barium, strontium, yttrium, lead, scandium, niobium, and zinc. Examples of materials that may be used in the gate dielectric 114 may include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, tantalum oxide, tantalum silicon oxide, lead scandium tantalum oxide, and lead zinc niobate. In some embodiments, an annealing process may be carried out on the gate dielectric 114 to improve the quality of the gate dielectric 114.

Each of the gates 106 may include a gate metal 110 and a hardmask 116. The hardmask 116 may be formed of silicon nitride, silicon carbide, or another suitable material. The gate metal 110 may be disposed between the hardmask 116 and the gate dielectric 114, and the gate dielectric 114 may be disposed between the gate metal 110 and the fin 104. Only one portion of the hardmask 116 is labeled in FIG. 2 for ease of illustration. In some embodiments, the gate metal 110 may be a superconductor, such as aluminum, titanium nitride (e.g., deposited via atomic layer deposition), or niobium titanium nitride. In some embodiments, the hardmask 116 may not be present in the quantum dot qubit device 100 (e.g., a hardmask like the hardmask 116 may be removed during processing, as discussed below). The sides of the gate metal 110 may be substantially parallel, as shown in FIG. 2, and insulating spacers 134 may be disposed on the sides of the gate metal 110 and the hardmask 116. As illustrated in FIG. 2, the spacers 134 may be thicker closer to the fin 104 and thinner farther away from the fin 104. In some embodiments, the spacers 134 may have a convex shape. The spacers 134 may be formed of any suitable material, such as a carbon-doped oxide, silicon nitride, silicon oxide, or other carbides or nitrides (e.g., silicon carbide, silicon nitride doped with carbon, and silicon oxynitride). The gate metal 110 may be any suitable metal, such as titanium nitride.

Each of the gates 108 may include a gate metal 112 and a hardmask 118. The hardmask 118 may be formed of silicon nitride, silicon carbide, or another suitable material. The gate metal 112 may be disposed between the hardmask 118 and the gate dielectric 114, and the gate dielectric 114 may be disposed between the gate metal 112 and the fin 104. In the embodiment illustrated in FIG. 2, the hardmask 118 may extend over the hardmask 116 (and over the gate metal 110 of the gates 106), while in other embodiments, the hardmask 118 may not extend over the gate metal 110. In some embodiments, the gate metal 112 may be a different metal from the gate metal 110; in other embodiments, the gate metal 112 and the gate metal 110 may have the same material composition. In some embodiments, the gate metal 112 may be a superconductor, such as aluminum, titanium nitride (e.g., deposited via atomic layer deposition), or niobium titanium nitride. In some embodiments, the hardmask 118 may not be present in the quantum dot qubit device 100 (e.g., a hardmask like the hardmask 118 may be removed during processing, as discussed below).

The gate 108 may extend between the proximate spacers 134 on the sides of the gate 106-1 and the gate 106-3, as shown in FIG. 2. In some embodiments, the gate metal 112 may extend between the spacers 134 on the sides of the gate 106-1 and the gate 106-3. Thus, the gate metal 112 may have a shape that is substantially complementary to the shape of the spacers 134, as shown. In some embodiments in which the gate dielectric 114 is not a layer shared commonly between the gates 108 and 106, but instead is separately deposited on the fin 104 between the spacers 134 (e.g., as discussed below with reference to FIGS. 40-44), the gate dielectric 114 may extend at least partially up the sides of the spacers 134, and the gate metal 112 may extend between the portions of gate dielectric 114 on the spacers 134. The gate metal 112, like the gate metal 110, may be any suitable metal, such as titanium nitride.

The dimensions of the gates 106/108 may take any suitable values. For example, in some embodiments, the z-height 166 of the gate metal 110 may be between 40 and 75 nanometers (e.g., approximately 50 nanometers); the z-height of the gate metal 112 may be in the same range. In embodiments like the ones illustrated in FIG. 2, the z-height of the gate metal 112 may be greater than the z-height of the gate metal 110. In some embodiments, the length 168 of the gate metal 110 (i.e., in the x-direction) may be between 20 and 40 nanometers (e.g., 30 nanometers). In some embodiments, the distance 170 between adjacent ones of the gates 106 (e.g., as measured from the gate metal 110 of one gate 106 to the gate metal 110 of an adjacent gate 106 in the x-direction, as illustrated in FIG. 2) may be between 40 and 60 nanometers (e.g., 50 nanometers). In some embodiments, the thickness 172 of the spacers 134 may be between 1 and 10 nanometers (e.g., between 3 and 5 nanometers, between 4 and 6 nanometers, or between 4 and 7 nanometers). The length of the gate metal 112 (i.e., in the x-direction) may depend on the dimensions of the gates 106 and the spacers 134, as illustrated in FIG. 2. As indicated in FIG. 1, the gates 106/108 on one fin 104 may extend over the insulating material 128 beyond their respective fins 104 and towards the other fin 104, but may be isolated from their counterpart gates by the intervening insulating material 130.

As shown in FIG. 2, the gates 106 and 108 may be alternatingly arranged along the fin 104 in the x-direction. During operation of the quantum dot qubit device 100, voltages may be applied to the gates 106/108 to adjust the potential energy in the quantum well layer (not shown) in the fin 104 to create quantum wells of varying depths in which quantum dots 142 may form. Only one quantum dot 142 is labeled with a reference numeral in FIGS. 2 and 3 for ease of illustration, but five are indicated as dotted circles in each fin 104, forming what may be referred to as a “quantum dot array.” The location of the quantum dots 142 in FIG. 2 is not intended to indicate a particular geometric positioning of the quantum dots 142. The spacers 134 may themselves provide “passive” barriers between quantum wells under the gates 106/108 in the quantum well layer, and the voltages applied to different ones of the gates 106/108 may adjust the potential energy under the gates 106/108 in the quantum well layer; decreasing the potential energy may form quantum wells, while increasing the potential energy may form quantum barriers.

The fins 104 may include doped regions 140 that may serve as a reservoir of charge carriers for the quantum dot qubit device 100. For example, an n-type doped region 140 may supply electrons for electron-type quantum dots 142, and a p-type doped region 140 may supply holes for hole-type quantum dots 142. In some embodiments, an interface material 141 may be disposed at a surface of a doped region 140, as shown. The interface material 141 may facilitate electrical coupling between a conductive contact (e.g., a conductive via 136, as discussed below) and the doped region 140. The interface material 141 may be any suitable material; for example, in embodiments in which the doped region 140 includes silicon, the interface material 141 may include nickel silicide.

The quantum dot qubit devices 100 disclosed herein may be used to form electron-type or hole-type quantum dots 142. Note that the polarity of the voltages applied to the gates 106/108 to form quantum wells/barriers depend on the charge carriers used in the quantum dot qubit device 100. In embodiments in which the charge carriers are electrons (and thus the quantum dots 142 are electron-type quantum dots), amply negative voltages applied to a gate 106/108 may increase the potential barrier under the gate 106/108, and amply positive voltages applied to a gate 106/108 may decrease the potential barrier under the gate 106/108 (thereby forming a potential well in which an electron-type quantum dot 142 may form). In embodiments in which the charge carriers are holes (and thus the quantum dots 142 are hole-type quantum dots), amply positive voltages applied to a gate 106/108 may increase the potential barrier under the gate 106/108, and amply negative voltages applied to a gate 106 and 108 may decrease the potential barrier under the gate 106/108 (thereby forming a potential well in which a hole-type quantum dot 142 may form). The quantum dot qubit devices 100 disclosed herein may be used to form electron-type or hole-type quantum dots.

Voltages may be applied to each of the gates 106 and 108 separately to adjust the potential energy in the quantum well layer under the gates 106 and 108, and thereby control the formation of quantum dots 142 under each of the gates 106 and 108. Additionally, the relative potential energy profiles under different ones of the gates 106 and 108 allow the quantum dot qubit device 100 to tune the potential interaction between quantum dots 142 under adjacent gates. For example, if two adjacent quantum dots 142 (e.g., one quantum dot 142 under a gate 106 and another quantum dot 142 under a gate 108) are separated by only a short potential barrier, the two quantum dots 142 may interact more strongly than if they were separated by a taller potential barrier. Since the depth of the potential wells/height of the potential barriers under each gate 106/108 may be adjusted by adjusting the voltages on the respective gates 106/108, the differences in potential between adjacent gates 106/108 may be adjusted, and thus the interaction tuned.

In some applications, the gates 108 may be used as plunger gates to enable the formation of quantum dots 142 under the gates 108, while the gates 106 may be used as barrier gates to adjust the potential barrier between quantum dots 142 formed under adjacent gates 108. In other applications, the gates 108 may be used as barrier gates, while the gates 106 are used as plunger gates. In other applications, quantum dots 142 may be formed under all of the gates 106 and 108, or under any desired subset of the gates 106 and 108.

Conductive vias and lines may make contact with the gates 106/108, and to the doped regions 140, to enable electrical connection to the gates 106/108 and the doped regions 140 to be made in desired locations. As shown in FIGS. 1-3, the gates 106 may extend away from the fins 104, and conductive vias 120 may contact the gates 106 (and are drawn in dashed lines in FIG. 2 to indicate their location behind the plane of the drawing). The conductive vias 120 may extend through the hardmask 116 and the hardmask 118 to contact the gate metal 110 of the gates 106. The gates 108 may extend away from the fins 104, and conductive vias 122 may contact the gates 108 (also drawn in dashed lines in FIG. 2 to indicate their location behind the plane of the drawing). The conductive vias 122 may extend through the hardmask 118 to contact the gate metal 112 of the gates 108. Conductive vias 136 may contact the interface material 141 and may thereby make electrical contact with the doped regions 140. The quantum dot qubit device 100 may include further conductive vias and/or lines (not shown) to make electrical contact to the gates 106/108 and/or the doped regions 140, as desired.

During operation, a bias voltage may be applied to the doped regions 140 (e.g., via the conductive vias 136 and the interface material 141) to cause current to flow through the doped regions 140. When the doped regions 140 are doped with an n-type material, this voltage may be positive; when the doped regions 140 are doped with a p-type material, this voltage may be negative. The magnitude of this bias voltage may take any suitable value (e.g., between 0.25 volts and 2 volts).

The conductive vias 120, 122, and 136 may be electrically isolated from each other by an insulating material 130. The insulating material 130 may be any suitable material, such as an interlayer dielectric (ILD). Examples of the insulating material 130 may include silicon oxide, silicon nitride, aluminum oxide, and/or silicon oxynitride. As known in the art of integrated circuit manufacturing, conductive vias and lines may be formed in an iterative process in which layers of structures are formed on top of each other. In some embodiments, the conductive vias 120/122/136 may have a width that is 20 nanometers or greater at their widest point (e.g., 30 nanometers), and a pitch of 80 nanometers or greater (e.g., 100 nanometers). In some embodiments, conductive lines (not shown) included in the quantum dot qubit device 100 may have a width that is 100 nanometers or greater, and a pitch of 100 nanometers or greater. The particular arrangement of conductive vias shown in FIGS. 1-3 is simply illustrative, and any electrical routing arrangement may be implemented.

As discussed above, the structure of the fin 104-1 may be the same as the structure of the fin 104-2; similarly, the construction of gates 106/108 on the fin 104-1 may be the same as the construction of gates 106/108 on the fin 104-2. The gates 106/108 on the fin 104-1 may be mirrored by corresponding gates 106/108 on the parallel fin 104-2, and the insulating material 130 may separate the gates 106/108 on the different fins 104-1 and 104-2. In particular, quantum dots 142 formed in the fin 104-1 (under the gates 106/108) may have counterpart quantum dots 142 in the fin 104-2 (under the corresponding gates 106/108). In some embodiments, the quantum dots 142 in the fin 104-1 may be used as “active” quantum dots in the sense that these quantum dots 142 act as qubits and are controlled (e.g., by voltages applied to the gates 106/108 of the fin 104-1) to perform quantum computations. The quantum dots 142 in the fin 104-2 may be used as “read” quantum dots in the sense that these quantum dots 142 may sense the quantum state of the quantum dots 142 in the fin 104-1 by detecting the electric field generated by the charge in the quantum dots 142 in the fin 104-1, and may convert the quantum state of the quantum dots 142 in the fin 104-1 into electrical signals that may be detected by the gates 106/108 on the fin 104-2. Each quantum dot 142 in the fin 104-1 may be read by its corresponding quantum dot 142 in the fin 104-2. Thus, the quantum dot qubit device 100 enables both quantum computation and the ability to read the results of a quantum computation.

Although not specifically shown in FIGS. 1-3, the quantum dot qubit device 100 may further include one or more accumulation gates used to form a 2DEG in the quantum well area between the area with the quantum dots and the reservoir such as e.g. the doped regions 140 which, as previously described, may serve as a reservoir of charge carriers for the quantum dot qubit device 100. Using such accumulation gates may allow to reduce the number of charge carriers in the area adjacent to the area in which quantum dots are to be formed, so that single charge carriers can be transferred from the reservoir into the quantum dot array. In various embodiments, an accumulation gate may be implemented on either side of an area where a quantum dot is to be formed.

Although also not specifically shown in FIGS. 1-3, some implementations of the quantum dot qubit device 100 further include or are coupled to a magnetic field source used for spin manipulation of the charge carriers in the quantum dots. In various embodiments, e.g. a microwave transmission line or one or more magnets with pulsed gates may be used as a magnetic field source. Once a quantum dot array is initialized by ensuring that a desired number of charge carriers are present in each quantum dot and ensuring the initial spins of these charge carriers, spin manipulation may be carried out with either a single spin or pairs of spin or possibly larger numbers of spins. In some embodiments, single spins may be manipulated using electron spin resonance with a rotating magnetic field (perpendicular to its static field) and on resonance with the transition energy at which the spin flips.

As discussed above, the base 102 and the fin 104 of a quantum dot qubit device 100 may be formed from a semiconductor substrate 144 and a quantum well stack 146 disposed on the semiconductor substrate 144. The quantum well stack 146 may include a quantum well layer in which a 2DEG may form during operation of the quantum dot qubit device 100. The quantum well stack 146 may take any of a number of forms, several of which are illustrated in FIGS. 4-6. The various layers in the quantum well stacks 146 discussed below may be grown on the semiconductor substrate 144 (e.g., using epitaxial processes).

FIG. 4 is a cross-sectional view of a quantum well stack 146 including only a quantum well layer 152. The quantum well layer 152 may be disposed on the semiconductor substrate 144, and may be formed of a material such that, during operation of the quantum dot qubit device 100, a 2DEG may form in the quantum well layer 152 proximate to the upper surface of the quantum well layer 152. The gate dielectric 114 of the gates 106/108 may be disposed on the upper surface of the quantum well layer 152. In some embodiments, the quantum well layer 152 of FIG. 4 may be formed of intrinsic silicon, and the gate dielectric 114 may be formed of silicon oxide; in such an arrangement, during use of the quantum dot qubit device 100, a 2DEG may form in the intrinsic silicon at the interface between the intrinsic silicon and the silicon oxide. In some such embodiments, the intrinsic silicon may be strained, while in other embodiments, the intrinsic silicon may not be strained. The thicknesses (i.e., z-heights) of the layers in the quantum well stack 146 of FIG. 4 may take any suitable values. For example, in some embodiments, the thickness of the quantum well layer 152 (e.g., intrinsic silicon) may be between 0.8 and 1.2 microns.

FIG. 5 is a cross-sectional view of a quantum well stack 146 including a quantum well layer 152 and a barrier layer 154. The quantum well stack 146 may be disposed on a semiconductor substrate 144 such that the barrier layer 154 is disposed between the quantum well layer 152 and the semiconductor substrate 144. The barrier layer 154 may provide a potential barrier between the quantum well layer 152 and the semiconductor substrate 144. As discussed above with reference to FIG. 4, the quantum well layer 152 of FIG. 5 may be formed of a material such that, during operation of the quantum dot qubit device 100, a 2DEG may form in the quantum well layer 152 proximate to the upper surface of the quantum well layer 152. For example, in some embodiments in which the semiconductor substrate 144 is formed of silicon, the quantum well layer 152 of FIG. 5 may be formed of silicon, and the barrier layer 154 may be formed of silicon germanium. The germanium content of this silicon germanium may be 20-80% (e.g., 30%). The thicknesses (i.e., z-heights) of the layers in the quantum well stack 146 of FIG. 5 may take any suitable values. For example, in some embodiments, the thickness of the barrier layer 154 (e.g., silicon germanium) may be between 0 and 400 nanometers. In some embodiments, the thickness of the quantum well layer 152 (e.g., silicon) may be between 5 and 30 nanometers.

FIG. 6 is a cross-sectional view of a quantum well stack 146 including a quantum well layer 152 and a barrier layer 154-1, as well as a buffer layer 176 and an additional barrier layer 154-2. The quantum well stack 146 may be disposed on the semiconductor substrate 144 such that the buffer layer 176 is disposed between the barrier layer 154-1 and the semiconductor substrate 144. The buffer layer 176 may be formed of the same material as the barrier layer 154, and may be present to trap defects that form in this material as it is grown on the semiconductor substrate 144. In some embodiments, the buffer layer 176 may be grown under different conditions (e.g., deposition temperature or growth rate) from the barrier layer 154-1. In particular, the barrier layer 154-1 may be grown under conditions that achieve fewer defects than the buffer layer 176. In some embodiments in which the buffer layer 176 includes silicon germanium, the silicon germanium of the buffer layer 176 may have a germanium content that varies from the semiconductor substrate 144 to the barrier layer 154-1. For example, the silicon germanium of the buffer layer 176 may have a germanium content that varies from zero percent at the silicon semiconductor substrate 144 to a nonzero percent (e.g., 30%) at the barrier layer 154-1. The thicknesses (i.e., z-heights) of the layers in the quantum well stack 146 of FIG. 6 may take any suitable values. For example, in some embodiments, the thickness of the buffer layer 176 (e.g., silicon germanium) may be between 0.3 and 4 microns (e.g., 0.3-2 microns, or 0.5 microns). In some embodiments, the thickness of the barrier layer 154-1 (e.g., silicon germanium) may be between 0 and 400 nanometers. In some embodiments, the thickness of the quantum well layer 152 (e.g., silicon) may be between 5 and 30 nanometers (e.g., 10 nanometers). In some embodiments, the thickness of the barrier layer 154-2 (e.g., silicon germanium) may be between 25 and 75 nanometers (e.g., 32 nanometers).

As discussed above with reference to FIG. 5, the quantum well layer 152 of FIG. 6 may be formed of a material such that, during operation of the quantum dot qubit device 100, a 2DEG may form in the quantum well layer 152 proximate to the upper surface of the quantum well layer 152. For example, in some embodiments in which the semiconductor substrate 144 is formed of silicon, the quantum well layer 152 of FIG. 6 may be formed of silicon, and the barrier layer 154-1 and the buffer layer 176 may be formed of silicon germanium. In some such embodiments, the silicon germanium of the buffer layer 176 may have a germanium content that varies from the semiconductor substrate 144 to the barrier layer 154-1. For example, the silicon germanium of the buffer layer 176 may have a germanium content that varies from zero percent at the silicon semiconductor substrate 144 to a nonzero percent (e.g., 30%) at the barrier layer 154-1. The barrier layer 154-1 may in turn have a germanium content equal to the nonzero percent. In other embodiments, the buffer layer 176 may have a germanium content equal to the germanium content of the barrier layer 154-1, but may be thicker than the barrier layer 154-1 so as to absorb the defects that may arise during growth. The barrier layer 154-2, like the barrier layer 154-1, may provide a potential energy barrier around the quantum well layer 152, and may take the form of any of the embodiments of the barrier layer 154-1. In some embodiments of the quantum well stack 146 of FIG. 6, the buffer layer 176 and/or the barrier layer 154-2 may be omitted.

The semiconductor substrate 144 and the quantum well stack 146 may be distributed between the base 102 and the fins 104 of the quantum dot qubit device 100, as discussed above. This distribution may occur in any of a number of ways. For example, FIGS. 7-13 illustrate example base/fin arrangements 158 that may be used in a quantum dot qubit device 100, in accordance with various embodiments.

In the base/fin arrangement 158 of FIG. 7, the quantum well stack 146 may be included in the fins 104, but not in the base 102. The semiconductor substrate 144 may be included in the base 102, but not in the fins 104. Manufacturing of the base/fin arrangement 158 of such embodiments may include fin etching through the quantum well stack 146, stopping when the semiconductor substrate 144 is reached.

In the base/fin arrangement 158 of FIG. 8, the quantum well stack 146 may be included in the fins 104, as well as in a portion of the base 102. A semiconductor substrate 144 may be included in the base 102 as well, but not in the fins 104. Manufacturing of the base/fin arrangement 158 of such embodiments may include fin etching that etches partially through the quantum well stack 146, and stops before the semiconductor substrate 144 is reached. FIG. 9 illustrates a particular embodiment of the base/fin arrangement 158 of FIG. 8. In the embodiment of FIG. 9, the quantum well stack 146 of FIG. 6 is used; the fins 104 include the barrier layer 154-1, the quantum well layer 152, and the barrier layer 154-2, while the base 102 includes the buffer layer 176 and the semiconductor substrate 144.

In the base/fin arrangement 158 of FIG. 10, the quantum well stack 146 may be included in the fins 104, but not the base 102. The semiconductor substrate 144 may be partially included in the fins 104, as well as in the base 102. Manufacturing the base/fin arrangement 158 of FIG. 10 may include fin etching that etches through the quantum well stack 146 and into the semiconductor substrate 144 before stopping. FIG. 11 illustrates a particular embodiment of the base/fin arrangement 158 of FIG. 10. In the embodiment of FIG. 11, the quantum well stack 146 of FIG. 6 is used; the fins 104 include the quantum well stack 146 and a portion of the semiconductor substrate 144, while the base 102 includes the remainder of the semiconductor substrate 144.

Although the fins 104 have been illustrated in many of the preceding figures as substantially rectangular with parallel sidewalls, this is simply for ease of illustration, and the fins 104 may have any suitable shape (e.g., shape appropriate to the manufacturing processes used to form the fins 104). For example, as illustrated in the base/fin arrangement 158 of FIG. 12, in some embodiments, the fins 104 may be tapered. In some embodiments, the fins 104 may taper by 3-10 nanometers in x-width for every 100 nanometers in z-height (e.g., 5 nanometers in x-width for every 100 nanometers in z-height). When the fins 104 are tapered, the wider end of the fins 104 may be the end closest to the base 102, as illustrated in FIG. 12. FIG. 13 illustrates a particular embodiment of the base/fin arrangement 158 of FIG. 12. In FIG. 13, the quantum well stack 146 is included in the tapered fins 104 while a portion of the semiconductor substrate 144 is included in the tapered fins and a portion of the semiconductor substrate 144 provides the base 102.

In the embodiment of the quantum dot qubit device 100 illustrated in FIG. 2, the z-height of the gate metal 112 of the gates 108 may be approximately equal to the sum of the z-height of the gate metal 110 and the z-height of the hardmask 116, as shown. Also in the embodiment of FIG. 2, the gate metal 112 of the gates 108 may not extend in the x-direction beyond the adjacent spacers 134. In other embodiments, the z-height of the gate metal 112 of the gates 108 may be greater than the sum of the z-height of the gate metal 110 and the z-height of the hardmask 116, and in some such embodiments, the gate metal 112 of the gates may extend beyond the spacers 134 in the x-direction.

### Example Quantum Circuit Assembly

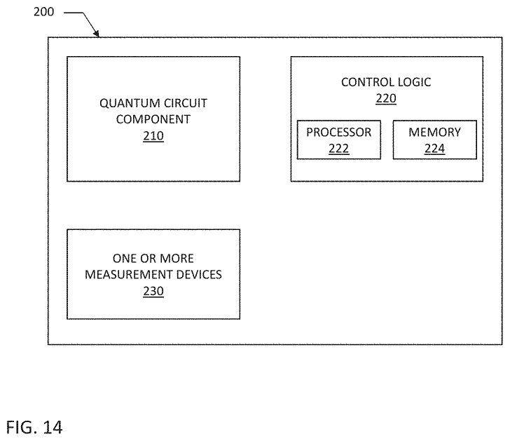

FIG. 14 provides a schematic illustration of a quantum circuit assembly 200 configured to implement adaptive programming of quantum dot qubit devices, according to some embodiments of the present disclosure. As shown in FIG. 14, the quantum circuit assembly 200 may include a quantum circuit component 210, a control logic 220, and one or more measurement devices 230.

The quantum circuit component 210 may be any component that can enable formation of one or more, typically a plurality, of qubits which may be used to perform quantum processing operations. For example, the quantum circuit component 210 may include one or more quantum dot qubit devices 100 in which one or more quantum dot qubits can be formed. However, in general, the quantum circuit component 210 may include any type of qubits, all of which are within the scope of the present disclosure.

The one or more measurement devices 230 may include any suitable devices for measuring measurable parameters (e.g. current, voltage, magnetic field, etc.) indicative of a state of the one or more quantum dot qubits included in the quantum circuit components 210. Example of such measurement devices 230 include, but are not limited to a resonator circuit for radio frequency (RF) reflectometry (which resonator circuit may be provided off-chip, i.e. on a different substrate or in a different IC package than the quantum circuit component 210), lock-in amplifier, and various suitable filters and amplifiers configured to perform measurements of parameters which are indicative of a state of the one or more quantum dot qubits included in the quantum circuit component 210.

FIG. 14 further illustrates that the quantum circuit assembly 200 further includes a control logic 220 configured to control adaptive programming of one or more quantum dot qubit devices included in the quantum circuit component 210 based on the measurements carried out by the one or more measurement devices 230. To that end, the quantum circuit component 210, the control logic 220, and the one or more measurement devices 230 may be communicatively connected with one another using suitable interconnects for communicating signals and data.

In some embodiments, the interconnects between the control logic 220 and the quantum circuit component 210 may include any type of interconnects suitable for enabling the control logic 220 to control the quantum circuit component 210. For example, such interconnects may include electrically conductive structures that would allow the control logic 220 to apply appropriate voltages to any of the plunger, barrier, and/or accumulation gates of one or more quantum dot arrays that may be realized in the quantum circuit component 210, and/or to apply microwave pulses to set the states of various quantum dot qubits in the quantum circuit component 210. In some embodiments, the interconnects between the control logic 220 and the quantum circuit component 210 may include electrically conductive structures that support direct currents. In some embodiments, the interconnects between the control logic 220 and the quantum circuit component 210 may include electrically conductive structures that support microwave currents or pulsed currents at microwave frequencies. Such interconnects may be implemented as microwave transmission lines using various transmission line architectures, such as e.g. a coplanar waveguide, a stripline, a microstrip line, or an inverted microstrip line. In some embodiments, the interconnects between the control logic 220 and the quantum circuit component 210 may be made from any of the superconductive materials as described herein.

In some embodiments, the interconnects between the control logic 220 and the one or more measurement devices 230 may include any type of interconnects suitable for communicating data between the control logic 220 and the one or more measurement devices 230, such as e.g. current readings, or any control parameters for the control logic 220 to control the operation of the one or more measurement devices 230.

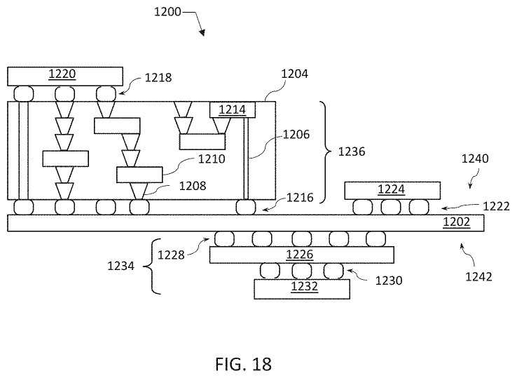

In some embodiments, at least portions, or all, of the control logic 220 may be advantageously integrated on the same die with at least portions, or all, of the quantum circuit component 210. In other embodiments, the control logic 220 may be provided on a different die. In some embodiments, at least portions, or all, of the one or more measurement devices 230 may be advantageously integrated on the same die with at least portions, or all, of the quantum circuit component 210. In other embodiments, the one or more measurement devices 230 may be provided on a different die. In general, the term “die” refers to a small block of semiconductor material/substrate on which a particular functional circuit is fabricated. An IC chip, also referred to as simply a chip or a microchip, sometimes refers to a semiconductor wafer on which thousands or millions of such devices or dies are fabricated. Other times, an IC chip refers to a portion of a semiconductor wafer (e.g. after the wafer has been diced) containing one or more dies. In general, a device is referred to as “integrated” if it is manufactured on one or more dies of an IC chip. In some embodiments, the control logic 220 and/or the one or more measurement devices 230 may be provided on a die that is separate from the die on which the quantum circuit component 210 is provided, but in a single IC package (e.g. the IC package as shown in FIG. 18).

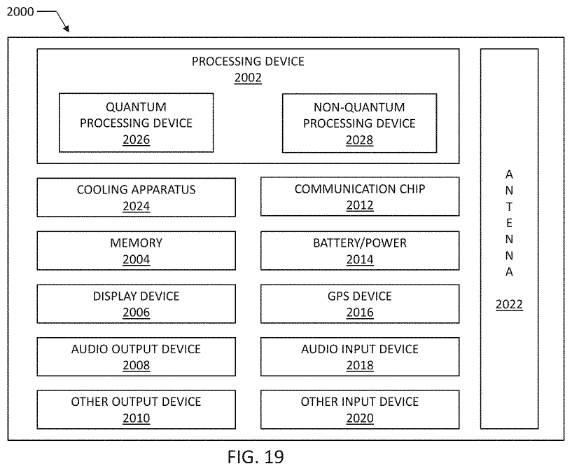

In some embodiments, the control logic 220 may provide peripheral logic to support the operation of the quantum circuit component 210. For example, the control logic 220 may control the performance of a read operation, control the performance of a write operation, control the clearing of quantum bits, etc., or, in general, control any of the operations described herein with reference to the quantum dot qubit device 100. The control logic 220 may also perform conventional computing functions to supplement the computing functions which may be provided by the quantum circuit component 210. For example, the control logic 220 may interface with one or more of the other components of a quantum computing device, such as e.g. a quantum computing device 2000 described below, and may serve as an interface between the quantum circuit component 210 and conventional components. In some embodiments, the control logic 220 may be implemented in or may be used to implement a non-quantum processing device 2028 described below with reference to FIG. 19.

In various embodiments, mechanisms by which the control logic 220 controls operation of the quantum circuit component 210, including adaptive programming as described herein, may be take the form of an entirely hardware embodiment, an entirely software embodiment (including firmware, resident software, micro-code, etc.) or an embodiment combining software and hardware aspects. For example, the control logic 220 may implement an algorithm executed by one or more processing units, e.g. one or more microprocessors, of one or more computers. In various embodiments, aspects of the present disclosure may take the form of a computer program product embodied in one or more computer readable medium(s), preferably non-transitory, having computer readable program code embodied, e.g., stored, thereon. In various embodiments, such a computer program may, for example, be downloaded (updated) to the control logic 220 or be stored upon manufacturing of the control logic 220.

In some embodiments, as shown in FIG. 14, the control logic 220 may include at least one processor 222 and at least one memory element 224, along with any other suitable hardware and/or software to enable its intended functionality of controlling operation of the quantum circuit component(s) 210 as described herein. The processor 222 can execute software or an algorithm to perform the activities as discussed herein. The processor 222 may be configured to communicatively couple to other system elements via one or more interconnects or buses. Such a processor may include any combination of hardware, software, or firmware providing programmable logic, including by way of non-limiting example a microprocessor, a digital signal processor (DSP), a field-programmable gate array (FPGA), a programmable logic array (PLA), an application specific integrated circuit (ASIC), or a virtual machine processor. The processor 222 may be communicatively coupled to the memory 224, for example in a direct-memory access (DMA) configuration. The memory 224 may include any suitable volatile or non-volatile memory technology, including double data rate (DDR) random access memory (RAM), synchronous RAM

(SRAM), dynamic RAM (DRAM), flash, read-only memory (ROM), optical media, virtual memory regions, magnetic or tape memory, or any other suitable technology. Any of the memory items discussed herein should be construed as being encompassed within the broad term “memory element.” The information being tracked or sent to the control logic 220 could be provided in any database, register, control list, cache, or storage structure, all of which can be referenced at any suitable timeframe. Any such storage options may be included within the broad term “memory element” (e.g. the memory 224) of the control logic 220 as used herein. Similarly, any of the potential processing elements, modules, and machines described herein should be construed as being encompassed within the broad term “processor” (e.g. the processor 222) of the control logic 220. The control logic 220 can further include suitable interfaces for receiving, transmitting, and/or otherwise communicating data or information in a network environment.

As described above, the control logic 220 may be configured to receive measurement readings (e.g. current readings) from the one or more measurement devices 230, determine various control parameters based on the measurement readings, and then exercise control over the operation of the quantum circuit component 210 using the determined control parameters, including exercising control of adaptive programming of the quantum circuit component 210. A specific nature of control that the control logic 220 would exercise over the operation of the quantum circuit component 210 would depend on the type of qubits that the quantum circuit component uses.

For example, if the quantum circuit component 210 uses quantum dot qubits as described above, the control logic 220 could be configured to determine, based on the measurement readings received from the one or more measurement devices 230, appropriate voltages to be applied to any one of plunger, barrier gates, and/or accumulation gates in order to initialize and manipulate the quantum dot qubits to be in desired states, and then control application of those voltages to the respective gates. Some examples of controlling the voltages on these gates are explained above with reference to the quantum dot qubit device 100. In the interests of brevity, these explanations are not repeated in detail here, but it is understood that, unless specified otherwise, all of the control mechanisms explained above may be performed by the control logic 220 based on the measurement readings received from the one or more measurement devices 230.

In some embodiments, the control logic 220 may be configured to use the received measurement readings to determine variations in gate voltages for forming different quantum dots. To that end, the control logic 220 may be configured to characterize formation of each quantum dot, i.e. to characterize at which gate voltage configurations the charge carriers can be exchanged between the neighboring quantum dots. The control logic may also be configured to read out the exchange of charge carriers in a first quantum dot array by reading out the transconductance of a set of quantum dots in a second quantum dot array adjacent to the first quantum dot array used as a single-electron transistor or any other suitable implementation of a single-electron transistor. The variations in gate voltages may then be determined based on an outcome of the characterization of the formation of the quantum dots.

In general, the term “plunger gate” is used to describe a gate under which an electro-static quantum dot is formed. By controlling the voltage applied to a plunger gate, the control logic 220 is able to modulate the electric field underneath that gate to create an energy valley (assuming electron-based quantum dot qubits) between the tunnel barriers created by the barrier gates.

In general, the term “barrier gate” is used to describe a gate used to set a tunnel barrier (i.e. a potential barrier) between either two plunger gates (i.e. controlling tunneling of charge carrier(s), e.g. electrons, from one quantum dot to an adjacent quantum dot) or a plunger gate and an accumulation gate. When the control logic 220 changes the voltage applied to a barrier gate, it changes the height of the tunnel barrier. When a barrier gate is used to set a tunnel barrier between two plunger gates, the barrier gate may be used to transfer charge carriers between quantum dots that may be formed under these plunger gates. When a barrier gate is used to set a tunnel barrier between a plunger gate and an accumulation gate, the barrier gate may be used to transfer charge carriers in and out of the quantum dot array via the accumulation gate.

In general, the term “accumulation gate” is used to describe a gate used to form a 2DEG in an area that is between the area where the quantum dots may be formed and a charge carrier reservoir. Changing the voltage applied to the accumulation gate allows the control logic 220 to control the number of charge carriers in the area under the accumulation gate. For example, changing the voltage applied to the accumulation gate allows reducing the number of charge carriers in the area under the gate so that single charge carriers can be transferred from the reservoir into the quantum dot array, and vice versa.

The control logic 220 may further be configured to control spins of charge carriers in quantum dots of the one or more qubits by controlling a magnetic field generated by the magnetic field generator. In this manner, the control logic 220 may be able to initialize and manipulate spins of the charge carriers in the quantum dots to implement qubit operations. Typically, the magnetic field generator generates a microwave magnetic field of a frequency matching that of the qubit. If the magnetic field for the quantum circuit component 210 is generated by a microwave transmission line, then the control logic 220 may set/manipulate the spins of the charge carriers by applying appropriate pulse sequences to manipulate spin precession. Alternatively, the magnetic field for the quantum circuit component 210 is generated by a magnet with one or more pulsed gates, in which case the control logic 220 may control the magnet in order to control the spin states of the quantum dot qubits.

In some embodiments, the control logic 220 may be configured to determine at least some values of the control parameters applied to the elements of the quantum circuit component 210 based on the measurement readings received from the one or more measurement devices 230, e.g. determine the voltages to be applied to the various gates of a quantum dot qubit device or determine the currents to be provided in various lines of a superconducting qubit device. In other embodiments, the control logic 220 may be pre-programmed with at least some of the control parameters, e.g. with the values for the voltages to be applied to the various gates of a quantum dot qubit device such as e.g. the device 100 during the initialization of the device.

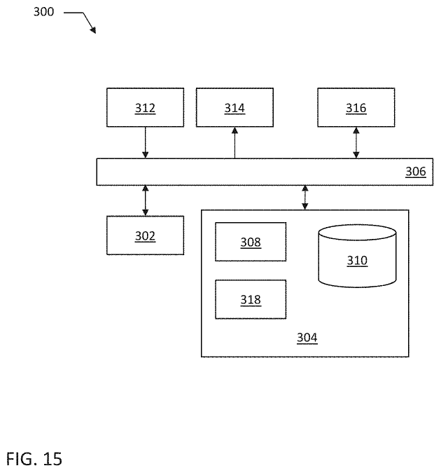

FIG. 15 provides a schematic illustration of a data processing system 300 configured to implement at least portions of adaptive programming of a quantum dot qubit device, according to some embodiments of the present disclosure. Such a data processing system could be configured to e.g. function as the control logic 220 described herein or as any other system participating in implementing at least portions of adaptive programming techniques as described herein.

As shown in FIG. 15, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. Descriptions provided with respect to the processor 302 shown in FIG. 15 are applicable to the processor 222 shown in FIG. 14, and vice versa. In one aspect, the data processing system may be implemented as a computer, e.g. as a non-quantum processing device 2028 shown in FIG. 19, that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the number of times program code must be retrieved from the bulk storage device 310 during execution. Descriptions provided with respect to the memory elements 304 shown in FIG. 15 are applicable to the memory 224 shown in FIG. 14, and vice versa.

Input/output (I/O) devices depicted as an input device 312 and an output device 314, optionally, can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 15 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also, optionally, be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 15, the memory elements 304 may store an application 318. In various embodiments, the application 318 may be stored in the local memory 308, the one or more bulk storage devices 310, or apart from the local memory and the bulk storage devices. It should be appreciated that the data processing system 300 may further execute an operating system (not shown in FIG. 15) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

### Implementing Adaptive Programming During Operation of a Quantum Dot Qubit Device

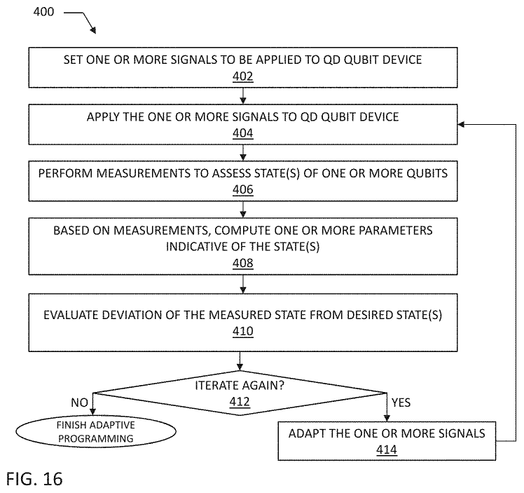

FIG. 16 provides a flow charts of an example method 400 of operating a quantum dot qubit device, namely of performing adaptive programming to initialize a quantum dot qubit device, according to some embodiments of the present disclosure. The quantum dot qubit device may be the quantum dot qubit device 100 described with reference to FIGS. 1-13, e.g. included within the quantum circuit component 210 shown in FIG. 14. Although the method 400 is described with reference to the quantum circuit assembly 200 shown in FIG. 14 implementing the quantum dot qubit device 100 shown in FIGS. 1-13, in general, any system, configured to implement the processes shown in FIG. 16, in any suitable order, is within the scope of the present disclosure.

The method 400 may begin with a process 402 in which the control logic 220 may set one or more signals to be applied to the quantum dot qubit device 100 in order to set one or more qubits of the quantum dot qubit device 100 to their respective desired states. In various embodiments, the one or more signals set in the process 402 may include one or more of the signals described below.

In some embodiments, the signals set in the process 402 may include signals applied to one or more of the plurality of gates, e.g. the gates 106/108, of the quantum dot qubit device 100. For example, when the plurality of gates include one or more plunger gates as described herein, the one or more signals set in the process 402 may include one or more signals to be applied (in process 404) to the respective plunger gates to control formation of one or more quantum dots in the quantum well stack of the quantum dot qubit device 100 under the plunger gates. In some embodiments, such signals may be DC voltage signals. In a further example, when the plurality of gates of the quantum dot qubit device 100 further include one or more barrier gates as described herein, the one or more signals set in the process 402 may further include one or more signals to be applied (in process 404) to the one or more barrier gates to control a potential barrier between two adjacent plunger gates or between a plunger gate and an adjacent accumulation gate. In some embodiments, the signals to be applied to the barrier gates may also be DC voltage signals. In another example, when the plurality of gates of the quantum dot qubit device 100 include one or more accumulation gates as described herein, the one or more signals set in the process 402 may include one or more signals to be applied (in process 404) to the one or more accumulation gates to control a number of charge carriers in an area between an area where one or more quantum dots are to be formed and a charge carrier reservoir. In some embodiments, the signals to be applied to the accumulation gates may also be DC voltage signals. As described above, applying signals to various gates of the quantum dot qubit device 100 allows generating single electrons at desired areas within the quantum well stack, which single electrons may serve as quantum dot qubits. In some embodiments, the one or more signals set in the process 402 include signals which are aimed to ensure that initially no charge carriers are present in the one or more quantum dots formed under the one or more plunger gates and then to ensure loading of a predefined number of charge carriers into each of the one or more quantum dots.

In some embodiments, the one or more signals set in the process 402 may include one or more microwave signals to be applied to one or more microwave lines in order to generate magnetic fields in the vicinity of various single electrons created in the quantum dot qubit device 100, where the magnetic fields are used to control the spin state of the electrons.

The method 400 may then proceed with a process 404 where the control logic 220 controls, e.g. enables, that the one or more signals set for the quantum dot qubit device 100 are applied to the device. For example, in some embodiments, application of signals in the process 404 may include the following. First, a source-drain bias may be applied to the quantum dot qubit device 100 (e.g. by applying bias voltage to one or both of the conductive vias 136 coupled to the doped regions 140, shown in FIG. 2, in each of the two fins 104-1 and 104-2 of the quantum dot qubit device 100 shown in FIG. 3). Next, gate bias is applied to the suitable ones of the gates 106/108 of the quantum dot qubit device 100 so that a single electron is formed either under each one of the gates 106/108, or only formed either under the gates 106 or under the gates 108. With single electrons under the appropriate gates (i.e. with qubits formed under the appropriate gates 106/108), the control logic 220 may control application of a magnetic field (either generated by a microwave signal applied to an on-chip microwave transmission line adjacent to the gate array of the gates 106 and 108, or generated by a suitable magnet, as described above) to initialize an electron under each desired gate to a spin up or a spin down state. In some of the embodiments where a magnetic field is generated by a current running in a microwave transmission line, an individual microwave transmission line may be provided for each of the gates 106 and 108; in other embodiments, a single microwave transmission line may be shared between two or more of the gates 106/108.

Application of the signals in the process 404 is aimed to achieve a certain state for each of one of more qubits of the quantum dot qubit device 100, but such a state is not necessarily achieved. Therefore, following the application of signals, the method 400 may proceed to a process 406 where the control logic 220 controls, e.g. enables, that the one or more measurement devices 230 perform suitable measurements to assess the state(s) of one or more qubits of the quantum dot qubit device 100. In other words, in the process 406, the control logic 220 reads the states of certain qubits of the quantum dot qubit device 100. As explained above, in order to read quantum dot qubits, pairs of qubits may be provided, with one qubit of a pair being on a different fin, e.g. as shown in FIG. 3. For example, if a given gate is used to form an active qubit that is to be initialized using adaptive programming, e.g. one of the gates 106/108 over the first fin 104-1 (e.g. the gate 106-2 on the first qubit 104-1, shown on the left side of FIG. 3), then the corresponding gate on the opposite fin (i.e. the gate 106-2 on the second fin 104-2 shown in FIG. 3) is used as a charge sensor (or a sense qubit) since an appropriate gate on this side has a single electron and electrostatically senses the state of the active qubit on the first fin 104-1. By measuring/monitoring the current of the charge sensor side using the one or more measurement devices 230, the spin state of the corresponding qubit can be assessed/determined.

The method 400 may then proceed with a process 408, in which the processor 222 of the control logic 220 may use the measurement data of the process 406 to compute one or more parameters indicative of the state of each of one or more qubits of the quantum dot qubit device 100. For example, in some embodiments, such a parameter may be a phase of the desired qubit of the quantum dot qubit device 100, where, as used in the art, the term “phase” of a quantum dot qubit refers to a position of a given qubit's spin state in Hilbert space among possible positions as the state may spin around any axis of the Hilbert space. In some embodiments, the control logic 220 may be configured to implement a Rabi oscillation experiment in order to determine a phase of a desired quantum dot qubit. In such an experiment, an active qubit is first initialized in a spin up or spin down state and then, using a driving magnetic field, the qubit is oscillated between the spin up and spin down states. The current measured after by the corresponding sense qubit after the active qubit was initialized to the initial qubit state may then be used by the control logic 220 as the calibrated value for comparison of the qubit phase after driving an oscillation for some predetermined amount of time. To determine the phase of the qubit after driving, the readout of a driven Rabi oscillation may be fed through a fast Fourier transform (FFT) to determine the Rabi reference frequency upon initialization. Afterwards, the qubit state may be continuously monitored and quadratures of signal from the qubit may be derived from amplified readout circuits, where, as is known in the art, quadrature is a term to describe a complex signal instead of a real signal, with the in-phase and quadrature components corresponding, respectively, to the real and imaginary parts of a complex signal. These measured signal and a suitable reference signal may then be multiplied with each other, e.g. using an analog multiplier, providing as an output a signal carrying the effective phase error of the qubit.

In other embodiments, the one or more parameters indicative of the state(s) of qubits of the quantum dot qubit device 100 may include amplitude of the qubit state given by the current measured of the charge sensing quantum dot. In some embodiments, an amplitude measurement may be calibrated to ‘ideal’ amplitude upon initialization, but will decay due to decoherence.

In general, as a part of the process 408, the processor 222 may be configured to carry out one or more of the following: perform FFT on driven qubit oscillations or employ other appropriate spectra analyses for describing an oscillating qubit state, take input of qubit readout signals to then digitize and place into an analog or other suitable multiplier, determine phase error from multiplication of reference oscillations to measured oscillations, compute tunneling rates of electrons in and out of occupation under plunger and barrier gates, and compute coherence times from decay plots of qubit state amplitude.

The method 400 may then proceed with a process 410, in which the processor 222 of the control logic 220 may evaluate deviation of the measured state, as defined by the one or more parameters computed in the process 408, from the desired state that was intended to be achieved by the application of the signals in the process 404. To that end, in some embodiments, the processor 222 may be configured to compare the magnitude of a signal that is output from the analog multiplier with a reference Rabi oscillation signal.

Subsequently, in a process 412, the control logic 220 may determine whether an iteration of the sequence of processes 404-410 is to be performed again, for an updated/adapted values of the one or more signals to be applied to the quantum dot qubit device 100. In some embodiments, a decision as to whether to iterate the sequence again may be based on the number of times the sequence has already been iterated. In such embodiments, the control logic 220 may be provided with some information as to the number of times the sequence is to be iterated (i.e. a target number of iterations) and keep track of this number in order to make the decision in the process 412 (the current number of iterations as well as the target number of iterations may be stored within the memory 224 of the control logic 220). In other embodiments, a decision as to whether to iterate the sequence again may be based on the outcome of the processes 408 and/or 410. For example, if a qubit is driven to determine the phase error accumulated during an operation, an amplifier and digitizer would deliver some quadratures of qubit readout signal to the processor for multiplication with a known, reference signal. If the resulting signal was found to be above the threshold phase error, the control logic 220 may decide to iterate with new control values on gates and microwave signal drive amplitude, phase, frequency and then run once more until phase error has been minimized.

If, in the process 412, the control logic 220 comes to the decision to not iterate again, the adaptive programming of the quantum dot qubit device 100 may be considered finished.

If, in the process 412, the control logic 220 comes to the decision to iterate again, the adaptive programming of the quantum dot qubit device 100 may proceed with a process 414 that includes the control logic 220 changing/adapting the values of at least some of the one or more signals applied in the process 404 of the iteration that just finished to fine-tune the signals in an attempt to achieve the desired state of the quantum dot qubit device 100. Thus, to implement adaptive programming, the qubit state may be first initialized (process 404), measured for spin up and/or spin down probability (process 406), then a compensation for the measured error may be be applied (process 414). In some embodiments, the error could be found to correlate with microwave signal duration delivered via the microwave transmission line. To fine-tune the signals applied to the quantum dot qubit device 100, the control logic 220 may be configured to adjust the duration of the applied microwave signal until the qubit state measured upon initialization is maximized and errors, e.g. errors as described above, are reduced.

In some embodiments, the control logic 220 may be configured to implement one or more machine learning algorithms to adapt the one or more signals in the process 414.

In some embodiments, the control logic 220 may be configured to determine a spin up and/or spin down probability of the at least one qubit as a part of the process 408, determine a deviation of the determined spin up and/or spin down probability from a desired value in the process 410, and, in the process 414, adapt the one or more signals to be applied to the quantum dot qubit device 100 based on the determined deviation.

From the process 414, the method 400 may proceed back to the process 404, described above, but now for the new set of signals to be applied, from which the method 400 may proceed as described above. The sequence may be iterated a plurality of times, e.g. a predetermined number of times, or e.g. until at least one parameter indicative of the state(s) of one or more quantum dot qubits of the quantum dot qubit device 100 satisfies one or more criteria. An example criteria could be a deviation of a parameter, e.g. a phase of a qubit, to be within a tolerance with respect to a certain expected/desired value.

### Example Devices and Systems

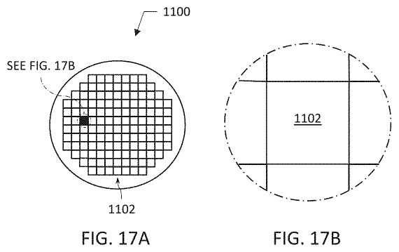

Quantum circuit assemblies that implement adaptive programming of quantum dot qubit devices as described above may be included in any kind of qubit devices or quantum processing devices/structures. Some examples of such devices/structures are illustrated in FIGS. 17A-17B, 18, and 19.

FIGS. 17A-17B are top views of a wafer 1100 and dies 1102 that may be formed from the wafer 1100, according to some embodiments of the present disclosure. The dies 1102 may include any of the quantum circuits assemblies disclosed herein, e.g. the quantum circuit assembly 200, or any further embodiments of such an assembly as described herein. The wafer 1100 may include semiconductor material and may include one or more dies 1102 having conventional and quantum circuit device elements formed on a surface of the wafer 1100. Each of the dies 1102 may be a repeating unit of a semiconductor product that includes any suitable conventional and/or quantum circuit qubit device. After the fabrication of the semiconductor product is complete, the wafer 1100 may undergo a singulation process in which each of the dies 1102 is separated from one another to provide discrete “chips” of the semiconductor product. A die 1102 may include the quantum circuit component 210 as described herein, as well as, optionally, at least portions of the control logic 220 (in case it is an on-chip control logic as described herein), as well as any other IC components. In some embodiments, the wafer 1100 or the die 1102 may include a memory device (e.g., a static random access memory (SRAM) device), a logic device (e.g., AND, OR, NAND, or NOR gate), or any other suitable circuit element. Multiple ones of these devices may be combined on a single die 1102. For example, a memory array formed by multiple memory devices may be formed on a same die 1102 as a processing device (e.g., the processing device 2002 of FIG. 19) or other logic that is configured to store information in the memory devices or execute instructions stored in the memory array.

FIG. 18 is a cross-sectional side view of a device assembly 1200 that may include any of the embodiments of the quantum circuit assemblies disclosed herein. The device assembly 1200 includes a number of components disposed on a circuit board 1202. The device assembly 1200 may include components disposed on a first face 1240 of the circuit board 1202 and an opposing second face 1242 of the circuit board 1202; generally, components may be disposed on one or both faces 1240 and 1242.

In some embodiments, the circuit board 1202 may be a printed circuit board (PCB) including multiple metal layers separated from one another by layers of dielectric material and interconnected by electrically conductive vias. Any one or more of the metal layers may be formed in a desired circuit pattern to route electrical signals (optionally in conjunction with other metal layers) between the components coupled to the circuit board 1202. In other embodiments, the circuit board 1202 may be a package substrate or flexible board.

The IC device assembly 1200 illustrated in FIG. 18 may include a package-on-interposer structure 1236 coupled to the first face 1240 of the circuit board 1202 by coupling components 1216. The coupling components 1216 may electrically and mechanically couple the package-on-interposer structure 1236 to the circuit board 1202, and may include solder balls (as shown in FIG. 18), male and female portions of a socket, an adhesive, an underfill material, and/or any other suitable electrical and/or mechanical coupling structure.

The package-on-interposer structure 1236 may include a package 1220 coupled to an interposer 1204 by coupling components 1218. The coupling components 1218 may take any suitable form for the application, such as the forms discussed above with reference to the coupling components 1216. Although a single package 1220 is shown in FIG. 18, multiple packages may be coupled to the interposer 1204; indeed, additional interposers may be coupled to the interposer 1204. The interposer 1204 may provide an intervening substrate used to bridge the circuit board 1202 and the package 1220. The package 1220 may be a quantum circuit device package as described herein, e.g. a package including any of the quantum circuit assemblies disclosed herein, e.g. one or more of quantum circuit assemblies configured to implement adaptive programming of quantum dot qubit devices as described herein, or may be a conventional IC package, for example. Generally, the interposer 1204 may spread a connection to a wider pitch or reroute a connection to a different connection. For example, the interposer 1204 may couple the package 1220 (e.g., a die) to a ball grid array (BGA) of the coupling components 1216 for coupling to the circuit board 1202. In the embodiment illustrated in FIG. 18, the package 1220 and the circuit board 1202 are attached to opposing sides of the interposer 1204; in other embodiments, the package 1220 and the circuit board 1202 may be attached to a same side of the interposer 1204. In some embodiments, three or more components may be interconnected by way of the interposer 1204.

The interposer 1204 may be formed of an epoxy resin, a fiberglass-reinforced epoxy resin, a ceramic material, or a polymer material such as polyimide. In some embodiments, the interposer 1204 may be formed of alternate rigid or flexible materials that may include the same materials described above for use in a semiconductor substrate, such as silicon, germanium, and other group III-V and group IV materials. The interposer 1204 may include metal interconnects 1208 and vias 1210, including but not limited to through-silicon vias (TSVs) 1206. The interposer 1204 may further include embedded devices 1214, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as RF devices, power amplifiers, power management devices, antennas, arrays, sensors, and microelectromechanical systems (MEMS) devices may also be formed on the interposer 1204. The package-on-interposer structure 1236 may take the form of any of the package-on-interposer structures known in the art.

The device assembly 1200 may include a package 1224 coupled to the first face 1240 of the circuit board 1202 by coupling components 1222. The coupling components 1222 may take the form of any of the embodiments discussed above with reference to the coupling components 1216, and the package 1224 may take the form of any of the embodiments discussed above with reference to the package 1220. The package 1224 may be a package including one or more of quantum circuit assemblies configured to implement adaptive programming of quantum dot qubit devices, or may be a conventional IC package, for example.

The device assembly 1200 illustrated in FIG. 18 includes a package-on-package structure 1234 coupled to the second face 1242 of the circuit board 1202 by coupling components 1228. The package-on-package structure 1234 may include a package 1226 and a package 1232 coupled together by coupling components 1230 such that the package 1226 is disposed between the circuit board 1202 and the package 1232. The coupling components 1228 and 1230 may take the form of any of the embodiments of the coupling components 1216 discussed above, and the packages 1226 and 1232 may take the form of any of the embodiments of the package 1220 discussed above. Each of the packages 1226 and 1232 may be a qubit device package implementing one or more of quantum circuit assemblies configured to implement adaptive programming of quantum dot qubit devices as described herein or may be a conventional IC package, for example.

FIG. 19 is a block diagram of an example quantum computing device 2000 that may include one or more of quantum circuit assemblies configured to implement adaptive programming of quantum dot qubit devices as disclosed herein. A number of components are illustrated in FIG. 19 as included in the quantum computing device 2000, but any one or more of these components may be omitted or duplicated, as suitable for the application. In some embodiments, some or all of the components included in the quantum computing device 2000 may be attached to one or more PCBs (e.g., a motherboard), and may be included in, or include, any of the quantum circuits with any of the quantum circuit assemblies described herein. In some embodiments, various ones of these components may be fabricated onto a single system-on-a-chip (SoC) die. Additionally, in various embodiments, the quantum computing device 2000 may not include one or more of the components illustrated in FIG. 19, but the quantum computing device 2000 may include interface circuitry for coupling to the one or more components. For example, the quantum computing device 2000 may not include a display device 2006, but may include display device interface circuitry (e.g., a connector and driver circuitry) to which a display device 2006 may be coupled. In another set of examples, the quantum computing device 2000 may not include an audio input device 2018 or an audio output device 2008, but may include audio input or output device interface circuitry (e.g., connectors and supporting circuitry) to which an audio input device 2018 or audio output device 2008 may be coupled.

The quantum computing device 2000 may include a processing device 2002 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 2002 may include a quantum processing device 2026 (e.g., one or more quantum processing devices), and a non-quantum processing device 2028 (e.g., one or more non-quantum processing devices). The quantum processing device 2026 may include any of the quantum circuit assemblies disclosed herein, e.g. one or more of quantum circuit assemblies configured to implement adaptive programming of quantum dot qubit devices as described herein, or any combinations of such assemblies, and may perform data processing by performing operations on the qubits that may be generated in the quantum circuit component 310, and monitoring the result of those operations. For example, as discussed above, different qubits may be allowed to interact, the quantum states of different qubits may be set or transformed, and the quantum states of different qubits may be read. The quantum processing device 2026 may be a universal quantum processor, or specialized quantum processor configured to run one or more particular quantum algorithms. In some embodiments, the quantum processing device 2026 may execute algorithms that are particularly suitable for quantum computers, such as cryptographic algorithms that utilize prime factorization, encryption/decryption, algorithms to optimize chemical reactions, algorithms to model protein folding, etc. The quantum processing device 2026 may also include support circuitry to support the processing capability of the quantum processing device 2026, such as input/output channels, multiplexers, signal mixers, quantum amplifiers, and analog-to-digital converters.

As noted above, the processing device 2002 may include a non-quantum processing device 2028. In some embodiments, the non-quantum processing device 2028 may provide peripheral logic to support the operation of the quantum processing device 2026. For example, the non-quantum processing device 2028 may control the performance of a read operation, control the performance of a write operation, control the clearing of quantum bits, etc. The non-quantum processing device 2028 may also perform conventional computing functions to supplement the computing functions provided by the quantum processing device 2026. For example, the non-quantum processing device 2028 may interface with one or more of the other components of the quantum computing device 2000 (e.g., the communication chip 2012 discussed below, the display device 2006 discussed below, etc.) in a conventional manner, and may serve as an interface between the quantum processing device 2026 and conventional components. The non-quantum processing device 2028 may include one or more digital signal processors (DSPs), application-specific ICs (ASICs), central processing units (CPUs), graphics processing units (GPUs), cryptoprocessors (specialized processors that execute cryptographic algorithms within hardware), server processors, or any other suitable processing devices.

The quantum computing device 2000 may include a memory 2004, which may itself include one or more memory devices such as volatile memory (e.g., dynamic random access memory (DRAM)), nonvolatile memory (e.g., read-only memory (ROM)), flash memory, solid-state memory, and/or a hard drive. In some embodiments, the states of qubits in the quantum processing device 2026 may be read and stored in the memory 2004. In some embodiments, the memory 2004 may include memory that shares a die with the non-quantum processing device 2028. This memory may be used as cache memory and may include embedded dynamic random access memory (eDRAM) or spin transfer torque magnetic random access memory (STT-MRAM).

The quantum computing device 2000 may include a cooling apparatus 2024. The cooling apparatus 2024 may maintain the quantum processing device 2026, in particular the quantum circuits 100 as described herein, at a predetermined low temperature during operation to avoid qubit decoherence and to reduce the effects of scattering in the quantum processing device 2026. This predetermined low temperature may vary depending on the setting; in some embodiments, the temperature may be 5 degrees Kelvin or less. In some embodiments, the non-quantum processing device 2028 (and various other components of the quantum computing device 2000) may not be cooled by the cooling apparatus 2030, and may instead operate at room temperature. The cooling apparatus 2024 may be, for example, a dilution refrigerator, a helium-3 refrigerator, or a liquid helium refrigerator.

In some embodiments, the quantum computing device 2000 may include a communication chip 2012 (e.g., one or more communication chips). For example, the communication chip 2012 may be configured for managing wireless communications for the transfer of data to and from the quantum computing device 2000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 2012 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 2012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 2012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2012 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2012 may operate in accordance with other wireless protocols in other embodiments. The quantum computing device 2000 may include an antenna 2022 to facilitate wireless communications and/or to receive other wireless communications (such as AM or FM radio transmissions).

In some embodiments, the communication chip 2012 may manage wired communications, such as electrical, optical, or any other suitable communication protocols (e.g., the Ethernet). As noted above, the communication chip 2012 may include multiple communication chips. For instance, a first communication chip 2012 may be dedicated to shorter-range wireless communications such as Wi-Fi or Bluetooth, and a second communication chip 2012 may be dedicated to longer-range wireless communications such as global positioning system (GPS), EDGE, GPRS, CDMA, WiMAX, LTE, EV-DO, or others. In some embodiments, a first communication chip 2012 may be dedicated to wireless communications, and a second communication chip 2012 may be dedicated to wired communications.

The quantum computing device 2000 may include battery/power circuitry 2014. The battery/power circuitry 2014 may include one or more energy storage devices (e.g., batteries or capacitors) and/or circuitry for coupling components of the quantum computing device 2000 to an energy source separate from the quantum computing device 2000 (e.g., AC line power).

The quantum computing device 2000 may include a display device 2006 (or corresponding interface circuitry, as discussed above). The display device 2006 may include any visual indicators, such as a heads-up display, a computer monitor, a projector, a touchscreen display, a liquid crystal display (LCD), a light-emitting diode display, or a flat panel display, for example.

The quantum computing device 2000 may include an audio output device 2008 (or corresponding interface circuitry, as discussed above). The audio output device 2008 may include any device that generates an audible indicator, such as speakers, headsets, or earbuds, for example.

The quantum computing device 2000 may include an audio input device 2018 (or corresponding interface circuitry, as discussed above). The audio input device 2018 may include any device that generates a signal representative of a sound, such as microphones, microphone arrays, or digital instruments (e.g., instruments having a musical instrument digital interface (MIDI) output).

The quantum computing device 2000 may include a GPS device 2016 (or corresponding interface circuitry, as discussed above). The GPS device 2016 may be in communication with a satellite-based system and may receive a location of the quantum computing device 2000, as known in the art.

The quantum computing device 2000 may include an other output device 2010 (or corresponding interface circuitry, as discussed above). Examples of the other output device 2010 may include an audio codec, a video codec, a printer, a wired or wireless transmitter for providing information to other devices, or an additional storage device.

The quantum computing device 2000 may include an other input device 2020 (or corresponding interface circuitry, as discussed above). Examples of the other input device 2020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The quantum computing device 2000, or a subset of its components, may have any appropriate form factor, such as a hand-held or mobile computing device (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computing device, a server or other networked computing component, a printer, a scanner, a monitor, a set-top box, an entertainment control unit, a vehicle control unit, a digital camera, a digital video recorder, or a wearable computing device.

### SELECT EXAMPLES

The following paragraphs provide examples of various ones of the embodiments disclosed herein.

Example 1 provides a quantum circuit assembly that includes a quantum circuit assembly that includes a quantum circuit component including a quantum dot qubit device; and a control logic coupled to the quantum circuit component and configured to iterate two or more times a sequence of applying one or more signals to the quantum dot qubit device and determining a state of at least one qubit of the quantum dot qubit device.

Example 2 provides the quantum circuit assembly according to example 1, where the quantum dot qubit device includes a quantum well stack and a plurality of gates above the quantum well stack, and where applying the one or more signals to the quantum dot qubit device includes applying one or more signals to one or more of the plurality of gates.

Example 3 provides the quantum circuit assembly according to example 2, where the plurality of gates include one or more plunger gates, and where applying the one or more signals to the quantum dot qubit device includes applying the one or more signals to the one or more plunger gates to control formation of one or more quantum dots in the quantum well stack, under the one or more plunger gates.

Example 4 provides the quantum circuit assembly according to example 3, where the plurality of gates include one or more barrier gates, and where applying the one or more signals to the quantum dot qubit device includes applying the one or more signals to the one or more barrier gates to control a potential barrier between two adjacent plunger gates or between a plunger gate and an adjacent accumulation gate.

Example 5 provides the quantum circuit assembly according to example 4, where applying the one or more signals to the quantum dot qubit device includes applying the one or more signals) aimed to ensure that initially no charge carriers are present in the one or more quantum dots formed under the one or more plunger gates and then to ensure loading of a predefined number of charge carriers into each of the one or more quantum dots.

Example 6 provides the quantum circuit assembly according to example 2, where the plurality of gates include one or more accumulation gates, and where applying the one or more signals to the quantum dot qubit device includes applying the one or more signals to the one or more accumulation gates to control a number of charge carriers in an area between an area where one or more quantum dots are to be formed and a charge carrier reservoir.

Example 7 provides the quantum circuit assembly according to any one of the preceding examples, where the at least one qubit is an active qubit of the quantum dot qubit device, the quantum dot qubit device further includes a sense qubit, and the control logic is configured to determine the state of the active qubit by determining a state of the sense qubit.

Example 8 provides the quantum circuit assembly according to any one of the preceding examples, where the sequence further includes adapting the one or more signals to be applied to the quantum dot qubit device based on at least one parameter indicative of the state of the at least one qubit of the quantum dot qubit device.

Example 9 provides the quantum circuit assembly according to example 8, where the at least one parameter includes a phase of the quantum dot qubit device.

Example 10 provides the quantum circuit assembly according to examples 8 or 9, where the control logic is configured to implement one or more machine learning algorithms to adapt the one or more signals.

Example 11 provides the quantum circuit assembly according to examples 8-10, where adapting the one or more signals includes determining a spin up and/or spin down probability of the at least one qubit, determining a deviation of the determined spin up and/or spin down probability from a desired value, and adapting the one or more signals based on the determined deviation.

Example 12 provides the quantum circuit assembly according to any one of examples 1-11, where iterating the sequence two or more times includes iterating the sequence a predefined number of times.

Example 13 provides the quantum circuit assembly according to any one of examples 1-11, where iterating the sequence two or more times includes iterating the sequence until at least one parameter satisfies at least one criterion.

Example 14 provides the quantum circuit assembly according to example 13, where the at least one criterion includes a deviation of the at least one parameter deviating from an expected value being within a tolerance.

Example 15 provides the quantum circuit assembly according to examples 13 or 14, where the at least one criterion is predefined (e.g. previously set, preprogrammed into the control logic, or stored in memory and accessible by the control logic).

Example 16 provides the quantum circuit assembly according to examples 13 or 14, where the at least one criterion is dynamically defined (e.g. the control logic is configured to determine what the at least one criterion should be based on e.g. the determined state of the at least one qubit of the quantum dot qubit device, or based on what the desired state of the at least one qubit of the quantum dot qubit device is).

Example 17 provides the quantum circuit assembly according to any one of examples 12-16, where the at least one parameter includes a parameter indicative of the state of the at least one qubit of the quantum dot qubit device, e.g. a phase of the at least one qubit of the quantum dot qubit device.

Example 18 provides the quantum circuit assembly according to any one of the preceding examples, where the quantum circuit component and the control logic are provided in a single integrated circuit (IC) package.

Example 19 provides the quantum circuit assembly according to any one of the preceding examples, where the quantum circuit component and the control logic are provided on a single die.

Example 20 provides the quantum circuit assembly according to any one of the preceding examples, where applying one or more signals to the quantum dot qubit device sets the state of the at least one qubit of the quantum dot qubit device.

Example 21 provides a method of operating a quantum dot qubit device, the method including applying one or more first signals to the quantum dot qubit device; following application of the one or more first signals, determining a state of at least one qubit of the quantum dot qubit device; adapting the one or more first signals based on the state of the at least one qubit to generate one or more second signals; and applying the one or more second signals to the quantum dot qubit device.

Example 22 provides the method according to example 21, where the quantum dot qubit device includes a quantum well stack and a plurality of gates above the quantum well stack, and where applying the one or more first signals and the one or more second signals includes applying signals to one or more of the plurality of gates.

Example 23 provides the method according to examples 21 or 22, where adapting the one or more first signals includes increasing a signal duration of a signal pulse.

Example 24 provides the method according to example 23, where the signal pulse is a microwave signal pulse.

Example 25 provides the method according to any one of examples 21-24, further including one or more processes for operating a quantum circuit assembly with the quantum dot qubit device according to any one of examples 1-20.

Example 26 provides a non-transitory computer readable storage medium storing software code portions configured for, when executed on a processor, control operation of a quantum dot device by controlling application of one or more first signals to the quantum dot qubit device; following application of the one or more first signals, determining a state of at least one qubit of the quantum dot qubit device; adapting the one or more first signals based on the state of the at least one qubit to generate one or more second signals; and controlling application of the one or more second signals to the quantum dot qubit device.

Example 27 provides the non-transitory computer readable storage medium according to example 26, where adapting the one or more first signals based on the state of the at least one qubit includes adapting the one or more first signals based on a spin state of the at least one qubit.

Example 28 provides the non-transitory computer readable storage medium according to examples 26 or 27, where controlling operation of the quantum dot device further includes one or more processes for operating a quantum circuit assembly with the quantum dot qubit device according to any one of examples 1-20.

Example 29 provides a quantum integrated circuit (IC) package that includes one or more dies and a further IC element, coupled to the one or more dies. The one or more dies include a quantum circuit component including a quantum dot qubit device, and a control logic coupled to the quantum circuit component and configured to iterate two or more times a sequence of applying one or more signals to the quantum dot qubit device and determining a state of the quantum dot qubit device (e.g. a state of at least one qubit of the quantum dot qubit device).

Example 30 provides the quantum IC package according to example 29, where the further IC element is coupled to the one or more dies by first level interconnects.

Example 31 provides the quantum IC package according to examples 30 or 31, where the further IC element is one of an interposer, a circuit board, a flexible board, or a package substrate.

Example 32 provides the quantum IC package according to any one of examples 29-31, where the quantum circuit component and the control logic form a quantum circuit assembly according to any one of examples 1-20.

Example 33 provides a quantum computing device that includes a quantum processing device that includes a quantum integrated circuit (IC) package including a plurality of qubit devices, the quantum IC package being Example provides the quantum IC package according to any one of examples 29-32; and a memory device configured to store data generated by the plurality of qubit devices during operation of the quantum processing device.

Example 34 provides the quantum computing device according to example 33, further including a cooling apparatus configured to maintain a temperature of the quantum processing device below 5 degrees Kelvin.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

1. A quantum circuit assembly, comprising:
a quantum circuit component including a quantum dot qubit device; and
a control logic coupled to the quantum circuit component and configured to iterate two or more times a sequence of applying one or more signals to the quantum dot qubit device and determining a state of at least one qubit of the quantum dot qubit device.

2. The quantum circuit assembly according to claim 1, wherein the quantum dot qubit device includes a quantum well stack and a plurality of gates above the quantum well stack, and wherein applying the one or more signals to the quantum dot qubit device includes applying one or more signals to one or more of the plurality of gates.

3. The quantum circuit assembly according to claim 2, wherein the plurality of gates include one or more plunger gates, and wherein applying the one or more signals to the quantum dot qubit device includes applying the one or more signals to the one or more plunger gates to control formation of one or more quantum dots, under the one or more plunger gates.

4. The quantum circuit assembly according to claim 3, wherein the plurality of gates include one or more barrier gates, and wherein applying the one or more signals to the quantum dot qubit device includes applying the one or more signals to the one or more barrier gates to control a potential barrier between two adjacent plunger gates or between a plunger gate and an adjacent accumulation gate.

5. The quantum circuit assembly according to claim 2, wherein the plurality of gates include one or more accumulation gates, and wherein applying the one or more signals to the quantum dot qubit device includes applying the one or more signals to the one or more accumulation gates to control a number of charge carriers in an area between an area where one or more quantum dots are to be formed and a charge carrier reservoir.

6. The quantum circuit assembly according to claim 1, wherein:
the at least one qubit is an active qubit of the quantum dot qubit device,
the quantum dot qubit device further includes a sense qubit, and
the control logic is configured to determine the state of the active qubit by determining a state of the sense qubit.

7. The quantum circuit assembly according to claim 1, wherein the sequence further includes adapting the one or more signals to be applied to the quantum dot qubit device based on at least one parameter indicative of the state of the at least one qubit of the quantum dot qubit device.

8. The quantum circuit assembly according to claim 7, wherein the at least one parameter includes a phase of the quantum dot qubit device.

9. The quantum circuit assembly according to claim 7, wherein the control logic is configured to implement one or more machine learning algorithms to adapt the one or more signals.

10. The quantum circuit assembly according to claim 7, wherein adapting the one or more signals comprises:
determining a spin up and/or spin down probability of the at least one qubit,
determining a deviation of the determined spin up and/or spin down probability from a desired value, and
adapting the one or more signals based on the determined deviation.

11. The quantum circuit assembly according to claim 1, wherein iterating the sequence two or more times includes iterating the sequence a predefined number of times.

12. The quantum circuit assembly according to claim 1, wherein iterating the sequence two or more times includes iterating the sequence until at least one parameter satisfies at least one criterion.

13. The quantum circuit assembly according to claim 12, wherein the at least one criterion includes a deviation of the at least one parameter deviating from an expected value being within a tolerance.

14. The quantum circuit assembly according to claim 12, wherein the at least one criterion is predefined.

15. The quantum circuit assembly according to claim 1, wherein the quantum circuit component and the control logic are provided in a single integrated circuit (IC) package.

16. The quantum circuit assembly according to claim 1, wherein the quantum circuit component and the control logic are provided on a single die.

17. The quantum circuit assembly according to claim 1, wherein applying one or more signals to the quantum dot qubit device sets the state of the at least one qubit of the quantum dot qubit device.

18. A method of operating a quantum dot qubit device, the method comprising:
applying one or more first signals to the quantum dot qubit device;
following application of the one or more first signals, determining a state of at least one qubit of the quantum dot qubit device;
adapting the one or more first signals based on the state of the at least one qubit to generate one or more second signals; and
applying the one or more second signals to the quantum dot qubit device.

19. The method according to claim 18, wherein the quantum dot qubit device includes a quantum well stack and a plurality of gates above the quantum well stack, and wherein applying the one or more first signals and the one or more second signals includes applying signals to one or more of the plurality of gates.

20. The method according to claim 18, wherein adapting the one or more first signals includes increasing a signal duration of a signal pulse.

21. The method according to claim 20, wherein the signal pulse is a microwave signal pulse.

22. A non-transitory computer readable storage medium storing software code portions configured for, when executed on a processor, control operation of a quantum dot device by:
controlling application of one or more first signals to the quantum dot qubit device;
following application of the one or more first signals, determining a state of at least one qubit of the quantum dot qubit device;
adapting the one or more first signals based on the state of the at least one qubit to generate one or more second signals; and
a controlling application of the one or more second signals to the quantum dot qubit device.

23. The non-transitory computer readable storage medium according to claim 22, wherein adapting the one or more first signals based on the state of the at least one qubit includes adapting the one or more first signals based on a spin state of the at least one qubit.

24. A quantum computing device, comprising:
a quantum processing device that includes a quantum dot qubit device comprising a plurality of qubits, the quantum processing device further including a control logic coupled to the quantum dot qubit device and configured to iterate a sequence of:
applying one or more signals to the quantum dot qubit device,
determining a state of at least one qubit of the plurality of qubits, and
adapting the one or more signals based on the determined state; and
a memory device configured to store data generated by the plurality of qubits during operation of the quantum processing device.

25. The quantum computing device according to claim 24, further comprising a cooling apparatus configured to maintain a temperature of the quantum processing device below 5 degrees Kelvin.
